(19) United States
(12) Patent Application Publication
(10) Pub. No.: US 2010/0299988 A1
(43) Pub. Date: Dec. 2, 2010

(54) ROD HOLDER

(76) Inventor: Cory Vincent Robinson, Hastings, MN (US)

Correspondence Address: GODFREY & KAHN S.C., 780 NORTH WATER STREET, MILWAUKEE, WI, 53202, US

(21) Appl. No.: 12/474,123

(22) Filed: May 28, 2009

(51) Int. Cl. A01K 97/10

(52) U.S. Cl. 43/21.2

(57) ABSTRACT

A rod holder for a fishing rod with a pair of spaced-apart saddles, at least of these saddles being open-topped, to receive a fishing rod from above. The saddles are spaced apart to permit a reel attached to the rod to be positioned between the saddles. The saddles mounted to a U-shaped bracket with a cross-piece and the saddles sufficiently vertically offset from the cross-piece to permit the reel to rest between the saddles hanging down.

### BACKGROUND

Rod holders for fishing rods have been in use for many years. Conventional approaches to the design and construction of such rod holders have included open-ended tubes into which a butt of a rod may be inserted or a ring and cradle combination where an end of the butt may be placed in the ring with another portion of the rod being held in the cradle. These conventional approaches to rod holders all require a distinct movement of the rod tip to disengage the rod from the holder.

Improvements to conventional rod holders are desirable.

### SUMMARY

The present disclosure relates generally to a rod holder for a fishing rod with a pair of spaced-apart saddles, at least one of these saddles being open-topped, to receive a fishing rod from above. The saddles are spaced apart to permit a reel attached to the rod to be positioned between the saddles. The saddles mounted to a U-shaped bracket with a cross-piece and the saddles sufficiently vertically offset from the cross-piece to permit the reel to rest between the saddles hanging down.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a perspective view of a rod holder according to the present disclosure.

FIG. 2 is a front view of the rod holder of FIG. 1.

FIG. 3 is a side view of the rod holder of FIG. 1.

FIG. 4 is a perspective view of a upper portion of the rod holder of FIG. 1 with coating of saddles removed.

FIG. 5 is a perspective view of the coating for the saddles of the rod holder of FIG. 1.

FIG. 6 is a side view of an alternative embodiment of a saddle and coating according to the present disclosure.

FIG. 7 is a perspective view of an alternative embodiment of a rod holder according to the present disclosure including a releasable rod lock.

FIG. 8 is a perspective view of an alternative cradle bracket according the present disclosure for use with a rod holder.

FIG. 9 is a perspective view of an alternative embodiment of a rod holder according to the present disclosure with an alternative locking arrangement.

FIG. 10 is a perspective view of an alternative embodiment of a rod holder according to the present disclosure with a pinned connection between the shaft and the base.

FIG. 11 is a perspective view of an alternative embodiment of a rod holder according to the present disclosure with a quarter-turn connection between the shaft and the base.

FIG. 12 is a perspective view of an alternative embodiment of a rod holder according to the present disclosure with a slip-fit connection between the shaft and the base.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

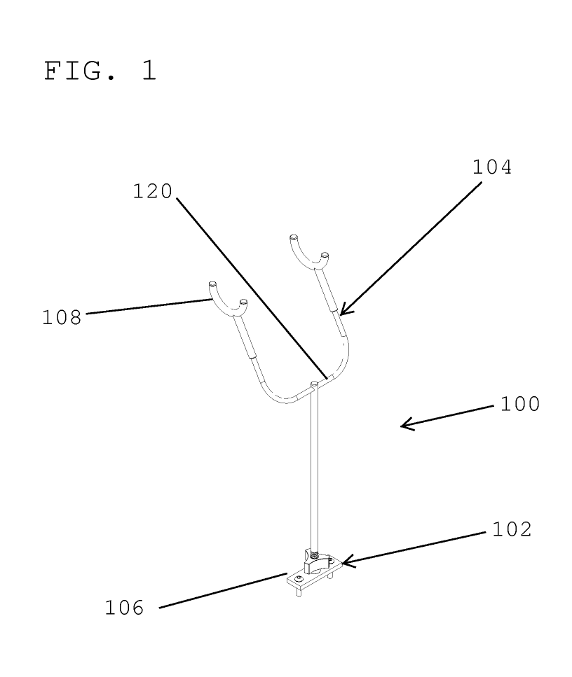

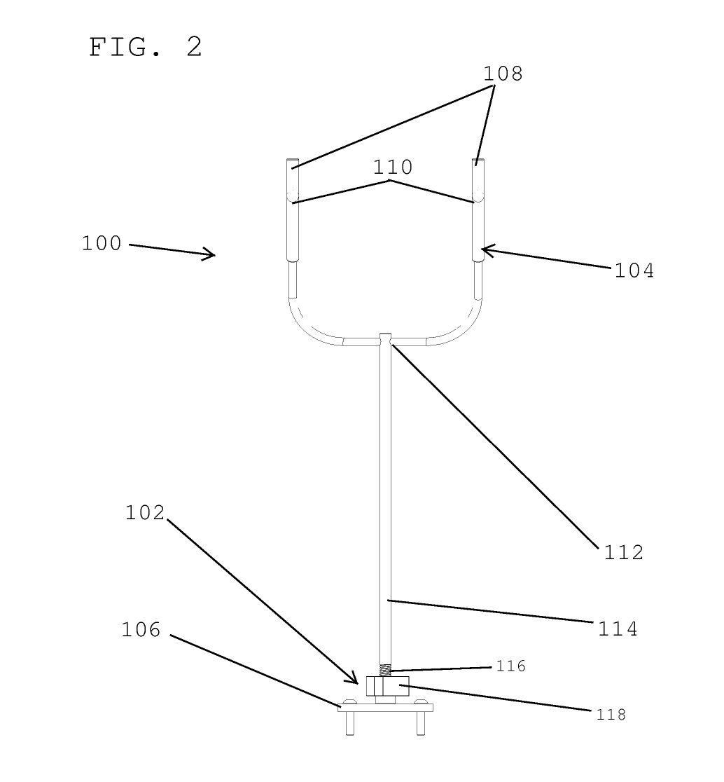

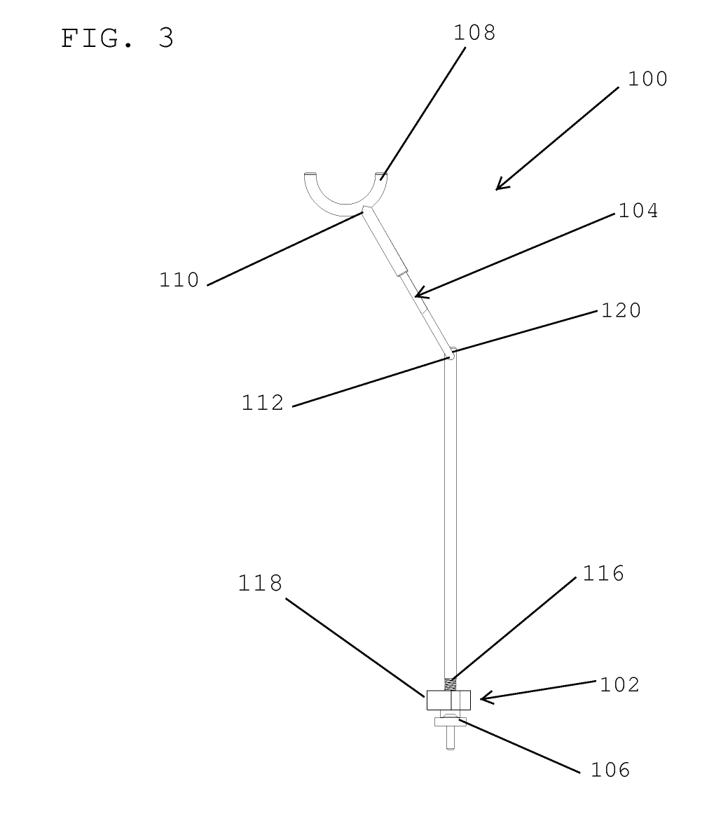

FIGS. 1 to 3 illustrate a rod holder 100 according to the present disclosure which may include a base 102 and a cradle bracket 104. At a lower end of base 102 may be a mount 106 configured to permit the attachment to another structure. Cradle bracket 104 may include one or more cradles 108 that are sized to receive the butt or shaft portion of a fishing rod. As shown, mount 106 is adapted to permit the bolting or other mounting by removable fasteners to a larger structure to anchor rod holder 100 in place adjacent a desired location. One preferred use of rod holder 100 may be adjacent a hole in the ice during ice fishing. Ice fishing rods tend to be shorter than more traditional fishing rods. In the configuration shown in FIG. 1, an ice fishing rod may be placed on cradles 108 with a butt of the rod on one cradle and a shaft of the rod on the other cradle. This would position the reel between the cradles and make the reel easily and quickly accessible to an angler when an indication of fish activity such as a nibble or a strike is seen.

It is anticipated that mount 106 may be configured to permit rod holder 100 to be mounted to a fishing bucket, a frame member or base of a portable ice shelter, an interior portion of an ice shanty, or any other structure or secure mounting base that may be available adjacent to an ice hole. It is also anticipated that rod holder 100 may be used for other fishing applications beyond ice fishing. As such, it is further anticipated that base 102 may be configured to mount to a portion of a boat, a dock or pier, shore structure, etc. As a further alternative, the base could be configured as a large enough plate or other structure so as to provide sufficient stability for use without attachment to any other object. Such a base might be large enough to rest directly on the ice adjacent a hole or the stability of such a base might be augmented with spikes to stakes to anchor the base to the ice or ground. While it is preferable to have the base be removably attached to an object to permit ease of portability, it is also anticipated that the base could be more permanently attached to another object, such as by an adhesive or other durable attachment means.

Cradles 108 as shown are preferable configured so that a rod placed in rod holder 100 is positioned generally horizontally. Many other rod holders tend to hold the rod at an upward angle so that the tip is higher than the butt of the rod. By mounting the rod generally horizontally, the tip is positioned closer to the water and may be better positioned to be able to indicate fish activity adjacent the bait or lure attached to the rod. Cradles 108 may be affixed to bracket 104 by welding, gluing or other adhesives, or other durable means of securement. Alternatively, bracket 104 and cradles 108 may be portions of an integrally formed upper portion of rod holder 100. One benefit to the horizontal arrangement of the cradles with respect to each other is that it may permit line from the reel to pass beneath the cradle holding the shaft of the rod, for example, adjacent upper ends 110 of cradle bracket 104. Having such a free flow of line from the reel to the rod guides and into the water will permit an angler to leave the bail of the reel open or place the reel in free-spool and have the line run free. If the rod is unattended or the associated line is hit with a rapid strike, the line could then run freely off the reel and prevent the rod from being pulled from the cradles and into the water.

Cradles 108 are positioned at upper ends 110 of cradle bracket 104. At a lower end 112 of cradle bracket 104, a cradle shaft 114 extends toward base 102. A threaded portion 116 of shaft 114 may be received within an opening of base 102. Threaded portion 116 may permit the height of cradles 108 above mount 106 to be adjusted as desired and also permitting rotational orientation of cradles 108 to be adjusted as desired with regard to base 102. A lock nut 118 may be provided to permit the position of the shafts to be secured with respect to each other in a desired orientation. Alternative arrangements between shaft 114, base 102 and locking mechanism 118 may include a quarter turn fastener to permit quick unlocking of cradle shaft 114, adjustment of height and rotation and quick relocking of the cradle shaft. The above examples are illustrative only and are not intended to limit the scope of the present disclosure. Other means of movably positioning the shaft with respect to the base are also within the scope of the present disclosure. It is also anticipated that the rod holder of the present disclosure may include cradle and base shafts which are fixed with respect to each other or may include cradle bracket 104 directly attached to an upper end of a base shaft extending upward from mount 106.

One feature of the base and mount that are desirably shown in the low profile nature of the lower portion of rod holder 100. In an ice shelter or a boat, where space may be at a premium, it is desirable to have the rod holder take up as little floor space as possible. The compact nature of the base as shown in the FIGS. will obstruct very little of the available floor space and should help avoid tripping or accidently bumping the rod holder as anglers move around with the shelter or boat.

By incorporating a single shaft between the base and the cradle bracket, an angler will be able to easily unlock and rotate the cradle bracket as necessary to ensure that the rod tip is positioned over the water to be fished. It is further within the scope of the present disclosure to have more than one shaft and cradle bracket mounted to a single base. Such a dual or multiple rod holder embodiment might have some limits to the angle through which of the cradle brackets might be rotated, the adjustability of each of the brackets will be maintained.

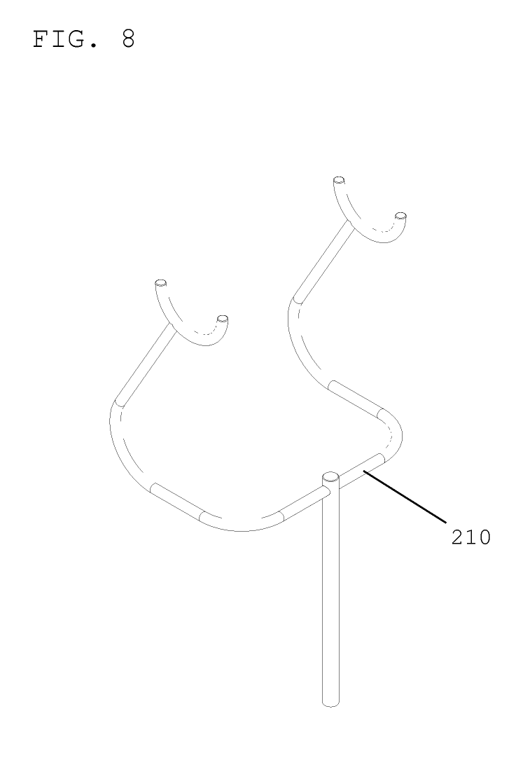

Alternative embodiments of rod holder 100 may include cradle brackets which are not uniformly shaped or U-shaped as shown in the FIGS. Other shapes and designs for the cradle bracket are anticipated within the scope of the present disclosure. Further, it is also anticipated that cradles 108 may be made of differing sizes or shapes to accommodate different sizes or diameters of rods and reels, as well as accommodating rods having butts and shafts of very different diameters or sizes. For example, a cradle configured to closely hold the shape and diameter of a fishing rod shaft may be sized to closely match the shaft size and shape to provide a more open path for the line coming off the reel to pass below the cradle as it extends to the lines guides of the rod. FIG. 8 illustrates an alternative shape for a cradle bracket 210 for use with a rod holder according to the present disclosure.

As shown, a line extending through cradles 108 is offset from a vertical extension of shaft 114. This angle may provide some benefit, permitting the base to be mounted to, for example, an interior wall of an ice shanty or to a chair that an angler may be seated in. This sort of mounting may assist in preserving floor space within an ice fishing shelter or in a boat where space may be at a premium. While the base might be directly adjacent a wall within the shanty or attached to a base or lower support for a chair, the vertical offset of the cradles would permit a rod to be placed in the cradles and held away from the wall or chair for easy access by an angler. Some portable fishing shelters include an integral floor tub with upwardly extending lower sidewalls and then a soft flexible upper shelter. For these types of fishing shelters, it is anticipated that the mount could be adapted for mounting to the sidewalls and having the cradles offset from the base to position the rod for use by an angler sitting within the shelter. Additional alternative bases might be adapted for mounting to a bucket that an angler brings adjacent the water for use as a stool. For other applications or mounting arrangements, the cradle bracket may be made with no vertical offset so that the cradles are positioned directly above the shaft.

The U-shape of cradle bracket 104 allows for a variety of reels to be used on rods placed on the rod holder of the present disclosure without the reel engaging the lower cross-piece 120 of the bracket. Because of the open top arrangement of at least one of the saddles or cradles 108, if a rod is placed within the cradles, the weight of a reel mounted to the rod will tend to cause the rod to lie with the reel positioned beneath the rod. By having cradles 108 positioned well above cross-piece 120, the reel in this position should not come into contact with the cross-piece.

Cradles 108 may also be preferably horizontally offset from each other to ensure that a reel will fit between the cradles when a rod is placed on rod holder 100. A wider spacing of the cradles than absolutely necessary for the reel alone may provide for more stability for the rod in the cradles as well as providing space for an angler to retrieve the rod and reel with gloved or mittened hands, if the rod holder is used for ice fishing.

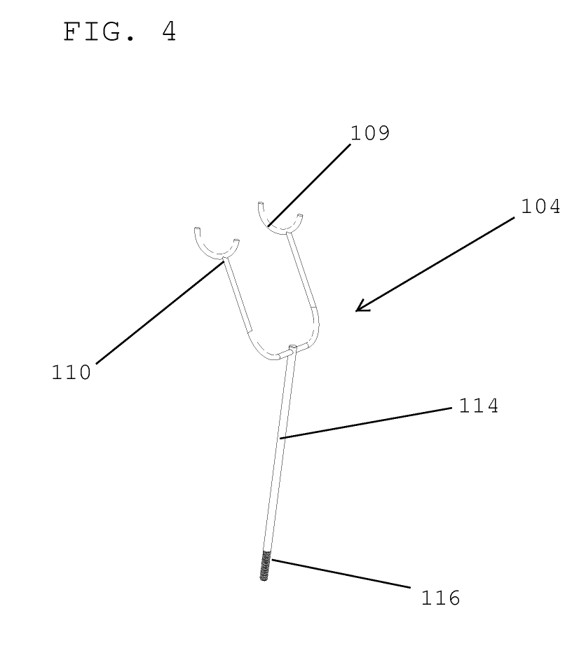

FIG. 4 illustrates cradle bracket 104 and shaft 112 which combined define an upper portion 130 of rod holder 100. In FIG. 4, a coating of saddles 108 has been removed and an underlying saddle structure 109 is shown. Structures 109 may be formed integrally with the rest of the U-shaped bracket of the upper portion or may be attached to the upper ends 110 of the bracket. The coating may be adhered to and cover the saddle structure and portions of the bracket by dipping or some other form of adherence to the saddle shape. Alternatively, a coating tape or other form of material may be wrapped about the portions of the saddles to be covered. One role for such a coating is to protect the anglers equipment (rods and reels) from scratching or other damages that may occur in normal use or in the case of a strong strike by a fish when the rod in within the cradles of rod holder 100.

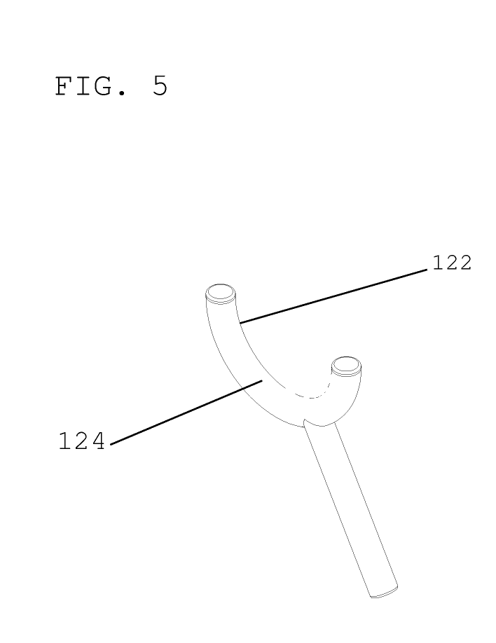

Referring now to FIG. 5, cradle structures 109 may be coated or covered in a softer material 122 such as plastic or some other polymeric compound to prevent vibrations from being transmitted through rod holder 100 to a rod in the holder. With such a coating or covering, core structure 109 of cradles 108 could be made from a rigid durable material such as metal or some hard plastic. Alternatively, the cradle structures 109 themselves may be made of a softer material that has sufficient rigidity to maintain its shape under the weight of a rod. These separate cradles could then be attached to the cross-piece to form bracket assembly 104.

It is further anticipated that a rod holder according to the present disclosure may be made by overmolding an interior structural skeleton with a suitable plastic or polymeric material, by injection molding in a suitable metallic, plastic or polymeric material, casting from a suitable metallic, plastic or polymeric material, or other similar processes.

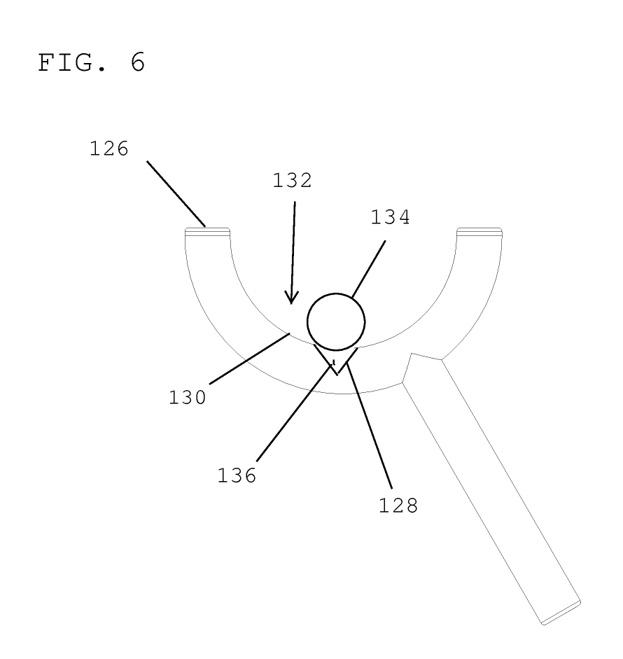

Cradles 108 may also be provided with a different shape for a saddle 124 into which the butt or shaft of a rod may be placed. While a generally uniform shape is shown for both cradles, it is anticipated that one or both of the cradles may be shaped differently. Such an alternative cradle 126 is illustrated in FIG. 6. Cradle 126 may include a saddle 132 with a lower groove 128 and an upper groove 130. Upper groove 130 is preferably sized to retain a fishing rod 134 while lower groove 128 would permit a fishing line 136 attached to rod 134 to pass freely through the cradle and not be trapped between the cradle and the rod itself Given the configuration of the bracket and saddles to receive a rod with an attached reel positioned between the saddles, such an arrangement of grooves would permit freer movement of line 136 when rod 134 is positioned in rod holder 100 without the need to remove the rod from the holder.

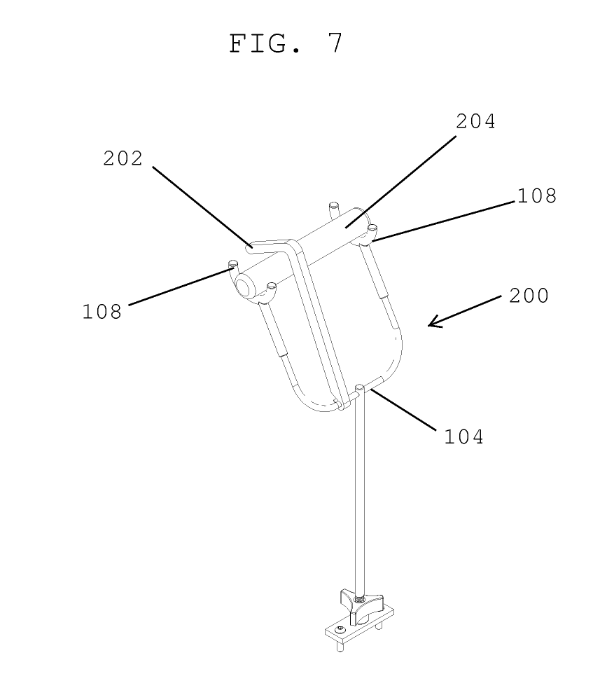

While the arrangement of cradles 108 may permit an open top to be used, it may also be desired to provide a releasable rod lock to retain the rod within holder 100. If an angler needs to leave the rod unattended or is distracted, the rod lock may be engaged to prevent the rod from being bumped or dragged out of the holder. To maintain the rapid and easy vertical lift to remove the rod from the cradles described above, it is desirable that such a rod lock be configured to easy engagement/disengagement and also given a desirable focus on ice fishing, it is desirable that such a rod lock be easily actuated by an angler wearing gloves or mittens. An alternative embodiment of a rod holder 200 with a rod lock 202 mounted to cradle bracket 104 is illustrated in FIG. 7, holding a rod butt 204 in place in cradles 108.

Other alternative rod locks may include but not be limited to a tether with a loop for attaching to the butt of the rod opposite the rod shaft, or an elastic or inelastic loop extending across the upper opening of the rearmost cradle 108.

A still further embodiment for a rod holder integrated with the saddles may be provided with an alternative construction of the saddle receiving the butt end of the rod. These rear saddle may be configured with the saddle laid back at an angle from vertical and the top of the saddle leaning away from the other front saddle. The rear saddle may be further configured with a closed top loop or ring. In such an alternative configuration, the ease of insertion of removal of the rod from the open topped rings may be maintained when the butt of the rod does not extend underneath the closed top of the backward angled ring while resting in the saddle. When it is desired to have the rod more securely held in the rod holder, the rod may be moved rearward until the butt of the rod in underneath the closed top of the saddle. This arrangement would then serve as a selectably engaged rod lock depending on the position of the rod within the saddles. Such a rod lock has an advantage of having no additional moving parts.

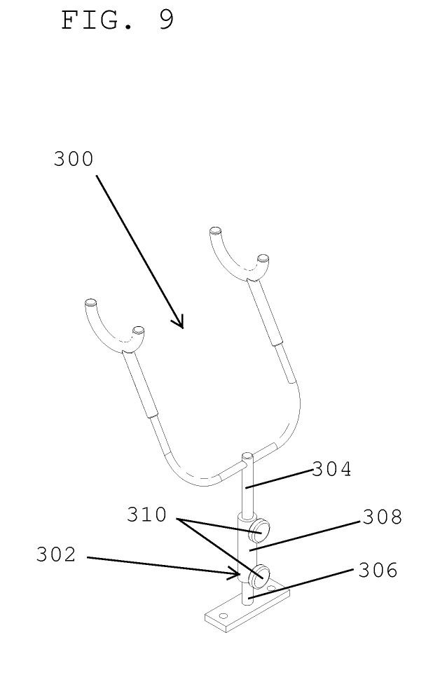

FIG. 9 illustrates an alternative rod holder 300 with a lower locking mechanism 302 including an upper shaft 304 as part of the cradle bracket, a lower shaft 306 as part of the base, with both of the shafts extending into a sleeve 308. A pair of locking knobs 310 may be provided in sleeve 308 to engage the shafts within the sleeve and hold the cradles in a desired position. Locking mechanism 302 may provide for both rotational and vertical adjustment. A further alternative might include sleeve 308 being affixed to one of the shafts and only a single locking knob 310 engaging the other shaft.

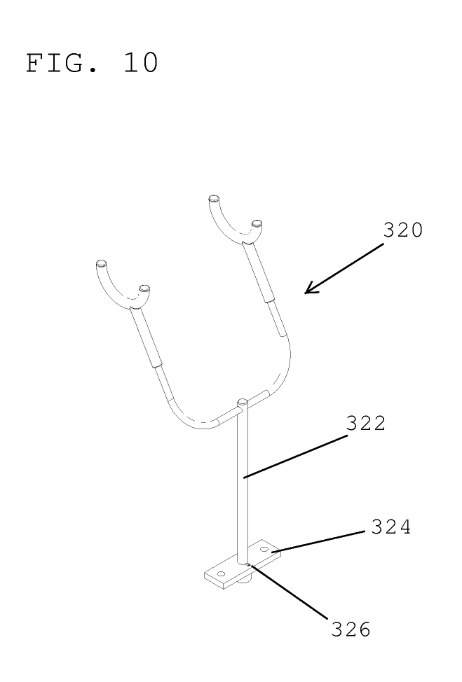

It is also anticipated that a rod holder according to the present disclosure may not require the adjustability in rotation or height. Such an alternative might be a lower cost model or for use in situations where the adjustability in not needed. FIG. 10 illustrates an alternative rod holder 320 with a bracket shaft 322 received within base 324. Rod holder 320 permits bracket shaft to be removed easily from base 324 but may include a key or pin feature on the shaft and base such as pin 326 on shaft 322 and a mating slot to receive the pin in base 322 to prohibit rotation of the cradles.

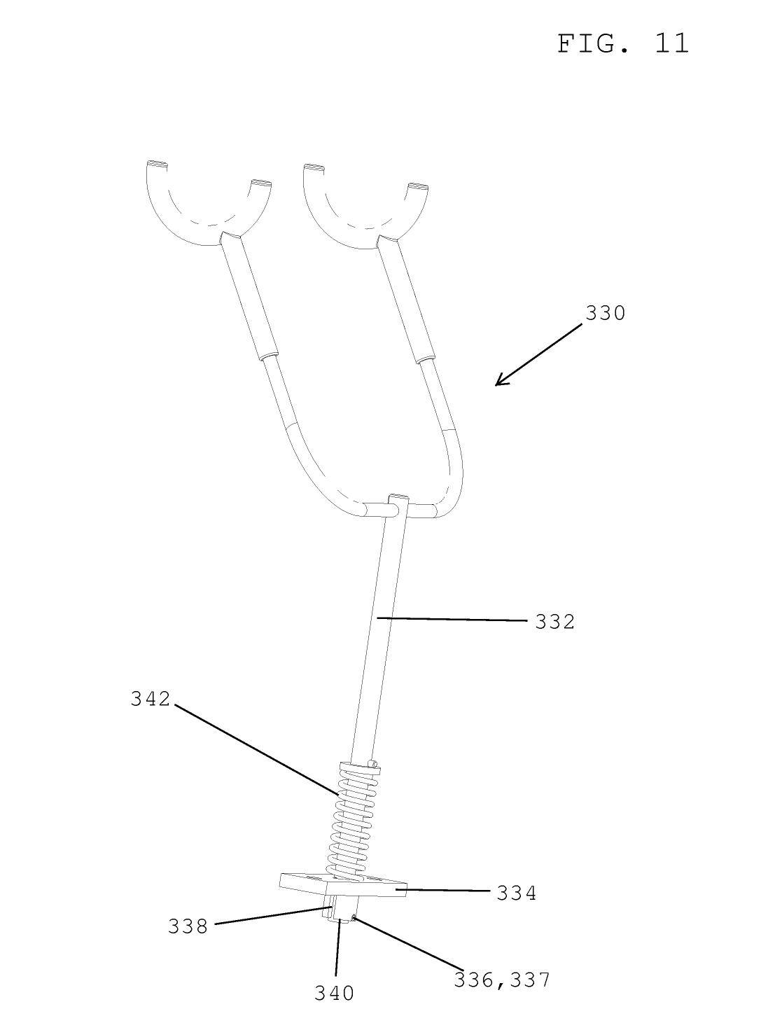

FIG. 11 illustrates a further embodiment of a rod holder 330 according to the present disclosure with a non-adjustable connection between a bracket shaft 332 and a base 334. Rod holder 320 does not include a means to securely connect and quickly release the shaft from the base. Rod holder 330 provides for a quarter-turn connection and release of shaft 332 and base 334. Shaft 332 includes a pin 336 adjacent a lower end. Base 334 includes a lower sleeve 340 with a corresponding groove 337 sized to receive pin 336. Spring 342 provides upward tension on shaft 332 to hold pin 336 in groove 337 and prevent the unwanted removal of the shaft from the base. While a coil spring is shown for spring 342, it is anticipated that other types of springs or elastic deformable materials may be used to provide the upward force against shaft 332. To release the shaft from the base, shaft 332 is pressed downward against spring 342 to move pin 336 from groove 337. Shaft 332 can then be rotated ninety degrees so that pin 336 is aligned with a slot 338 in sleeve 340. Slot 338 extends entirely through sleeve 340 so that shaft 332 can be removed base 334 once pin 336 and slot 338 are aligned.

It is also anticipated that the rod holder of FIG. 11 may include a plurality of detents or other similar features that may be used to hold the upper portion of the rod holder in a variety of rotational positions. FIG. 11 illustrates only a single detent configuration that can provide two distinct rotational positions. Additional grooves may be provided in the base to permit additional positioned into which the rod holder may be rotated.

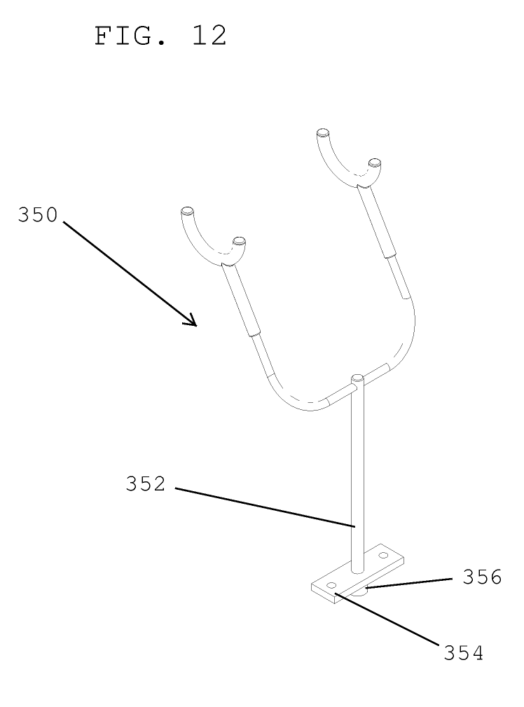

Referring now to FIG. 12, a further alternative embodiment 350 is configured to have a shaft 352 slip or friction fit within a sleeve 356 of a base 354 as a simplest form of removable connection between the shaft and the base. This arrangement may permit some degree of rotation of the cradles and no height adjustment but should the simplest and cheapest to manufacture.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A rod holder comprising:
an upper portion and a base;
the upper portion including one or more saddles for receiving a fishing rod, at least one of the saddles having an open top permitting the rod to be placed into the saddles from above, the saddles being mounted upper extensions of a saddle bracket, the saddle bracket being substantially U-shaped, the saddles spaced apart from each other sufficiently to receive a fishing rod with an attached fishing reel positioned between the saddles, the bracket further including a cross-piece extending across the base of the U-shape;
the upper portion further including a bracket shaft extending downward from the cross-piece;
the base including a mount for attachment to a stable point, the mount including an opening to receive a lower end of the bracket shaft;
the bracket shaft being rotatable within the opening of the mount to permit the orientation of the saddles with regard to the base to be altered;
the bracket shaft being movable with respect to the mount to permit the height of the saddles above the base to be altered.

2. The rod holder of claim 1, wherein the bracket shaft is threadably received within an opening of the mount and rotation of the shaft with respect to the base permits the orientation and height of the saddles with regard to the base to be altered.

3. The rod holder of claim 2, further comprising a lock nut positioned about the bracket shaft, the lock nut configured to hold the saddles at a desired orientation and height with regard to the base.

4. The rod holder of claim 1, wherein the saddles are offset vertically from the bracket shaft.

5. The rod holder of claim 1, further comprising the saddles including a soft coating about an underlying saddle structure.

6. The rod holder of claim 1, wherein at least one of the saddles includes a first groove and a second groove, with the first groove sized to receive a fishing rod and the second groove sized to receive the fishing line and not the rod to permit a fishing line to pass through the saddle.

7. The rod holder of claim 1, further comprising two saddles, wherein one of the saddles is a rear saddle and is configured to receive a butt of a fishing rod, the rear saddle further comprising a closed ring over the saddle that is angled away from the other saddle so that the rod may be placed within and removed from the saddles vertically, or the rod may be selectively placed within the saddles vertically and moved rearward so that the butt is beneath the closed ring of the rear saddle.

8. A rod holder comprising:
an upper portion and a base;
the upper portion including one or more saddles for receiving a fishing rod, at least one of the saddles having an open top permitting the rod to be placed into the saddles from above, the saddles being mounted upper extensions of a saddle bracket, the saddle bracket being substantially U-shaped, the saddles spaced apart from each other sufficiently to receive a fishing rod with an attached fishing reel positioned between the saddles, the bracket further including a cross-piece extending across the base of the U-shape, the saddles and the bracket configured so that when the fishing rod may be placed in the saddles, a line extending from the reel of the fishing rod will pass below one of the saddles as the line extends toward the end of the fishing rod;
the saddles further comprising a softer surface in the area where the fishing rod will rest to prevent damage to the fishing rod;
the upper portion further including a bracket shaft extending downward from the cross-piece;
the base including a mount for attachment to a stable point, the mount including an opening to receive a lower end of the bracket shaft;
the bracket shaft being releasably received within the opening of the base.

9. The rod holder of claim 8, wherein the bracket shaft is releasably received within the opening of the base with a friction fit.

10. The rod holder of claim 8, wherein the bracket shaft includes a pin and the base opening includes a mating slot so that the shaft is held within the opening to prevent rotation of the shaft relative to the base.

11. The rod holder of claim 8, wherein the bracket shaft is releasably received within the opening of the base with a quarter-turn fastening.

12. The rod holder of claim 8, further comprising two saddles, wherein one of the saddles is a rear saddle and is configured to receive a butt of a fishing rod, the rear saddle further comprising a closed ring over the saddle that is angled away from the other saddle so that the rod may be placed within and removed from the saddles vertically, or the rod may be selectively placed within the saddles vertically and moved rearward so that the butt is beneath the closed ring of the rear saddle.
